(19) United States
(12) Patent Application Publication
(10) Pub. No.: US 2018/0223972 A1
(43) Pub. Date: Aug. 9, 2018

(54) LINEAR STEPPER MOTOR WITH ROTOR SPINDLE FOR LINEARLY GUIDED ACTUATOR

(71) Applicant: Johnson Electric S.A., Murten (CH)

(72) Inventors: Sten Währisch, Dresden (DE); Gerd Howack, Kreischa (DE); Thomas Müller, Dresden (DE)

(21) Appl. No.: 15/891,654

(22) Filed: Feb. 8, 2018

(30) Foreign Application Priority Data
Feb. 9, 2017 (DE) 20 2017 100 708.1

(51) Int. Cl. F16H 25/20; H02K 5/167; H02K 7/06; H02K 7/08

(52) U.S. Cl. CPC F16H 25/20; H02K 5/1672; F16H 2025/204; H02K 7/083; F16H 2025/2078; H02K 7/06

(57) ABSTRACT

A linear stepper motor includes a rotor, two plain bearings, two motor bearing shields, a spindle nut, and a fork-shaped actuating rod. The rotor has a rotor shaft that comprises a motive thread and is configured to drive a linearly guided actuator. The rotor shaft has plain bearing journals at ends thereof, which each comprise an end radially and axially enclosed in the plain bearings seated in the motor bearing shields, and, by the motive thread, axially drives the spindle nut connected with the fork-shaped actuating rod in a rotation-proof manner. The rotor shaft includes a flexurally and torsionally rigid plastic threaded spindle with coaxially arranged metallic shaft ends so as to act as metallic journals on opposite ends for concurrent plain bearing support and axial support.

### CROSS REFERENCE TO RELATED APPLICATIONS

This non-provisional patent application claims priority under 35 U.S.C. § 119(a) from Patent Application No. 202017100708.1 filed in the Federal Republic of Germany on Feb. 9, 2017.

### FIELD

The present disclosure relates to a linear stepper motor whose rotor shaft provided with a male thread drives a linearly guided actuator for valves for example. The rotor shaft has plain bearing journals at its axial ends enclosed radially and axially in plain bearings seated in the motor bearing shields and, with its male thread, axially driving a rotation-locked spindle nut linked with a fork-shaped actuator rod.

### BACKGROUND

A generic linear stepper motor is known from Germany patent application NO. DE 103 32 389 A1. Furthermore, a threaded mechanism made of plastic materials and metal and having a trapezoidal thread is known from Germany patent application NO. DE 10 2010 005 145 A1, e.g., for fittings, specifically valves, where for purposes of reduced material wear either the threaded nut is made of metal and the spindle is made of plastic material or vice versa.

A screw, threaded spindle or equivalent with its core made of steel or similar material and its thread made of plastics for general use in machines or other devices is also known from Germany patent application NO. DE 1 891 224 U1. To retain the thread shell, the core has recesses or similar distributed along its circumference.

### SUMMARY

The disclosure is based on the task to provide a hard-wearing, low-tolerance and cost-efficient rotor shaft having a motive thread for linear motors and having plain bearing journals on opposite ends for support in a linear motor. The rotor shaft with its motive thread is to be designed for linear propulsion of an actuating rod according to a spindle-nut principle such that the plain bearing journal design can be separated from the design of the rotor shaft, permitting compliance with different technical and structural requirements independently of each other. The rotor shaft should be supported with as little play and as smooth-running as possible in the bearing shells of the linear motor. It should be maintenance-free and manage without any lubricant in the nut-spindle drive as well as be able at any level of miniaturization to transmit high actuating forces without jamming or bending and adapt without problems to tailoring for customer-specific actuating tasks.

The task is solved according to the disclosure by a rotor shaft including a flexurally and torsionally rigid plastic threaded spindle from which protrude coaxial metallic plain bearing journals of high surface quality at opposite ends. The plain bearing journals are guided both radially and axially in plain bearings of the bearing shields. The rotor shaft with its male motive thread, for example a trapezoidal thread, is made of a rigid, hard-wearing plastic material in an injection molding process or is made of two different plastic materials of different strength and/or lubrication characteristics by selecting specific customized gear modules for the threaded spindle. The plain bearing journals themselves can also be part of a continuous metallic journal axle or include two separate metallic journals positioned only at the ends and insert-molded when injection molding the rotor shaft. Additionally, in a further embodiment of the disclosure, the rotor shaft can bear a molded-on neck flange on the drive side for a rotation-locked connection with the rotor magnet. Also, according to another embodiment of the disclosure, insert-molding of the rotor magnet directly onto the rotor shaft can be provided, which makes it possible to achieve less eccentricity and thus a smaller air gap towards the stator, resulting in greater overall efficiency of the motor. At their ends, the plain bearing journals are designed such that, in addition to support in a radial plain bearing, low-friction axial support can be implemented by means of balls holding the pointed tips.

### BRIEF DESCRIPTION OF THE DRAWINGS

FIG. 1 shows an example with two metallic journals as plain bearing journals.

FIG. 2 shows an example with a continuous journal axle for the plain bearing journals.

### DETAILED DESCRIPTION

Embodiments of the present disclosure will be described in detail in conjunction with the drawings. It should be noted that the figures are illustrative rather than limiting. The figures are not drawn to scale, do not illustrate every aspect of the described embodiments, and do not limit the scope of the present disclosure.

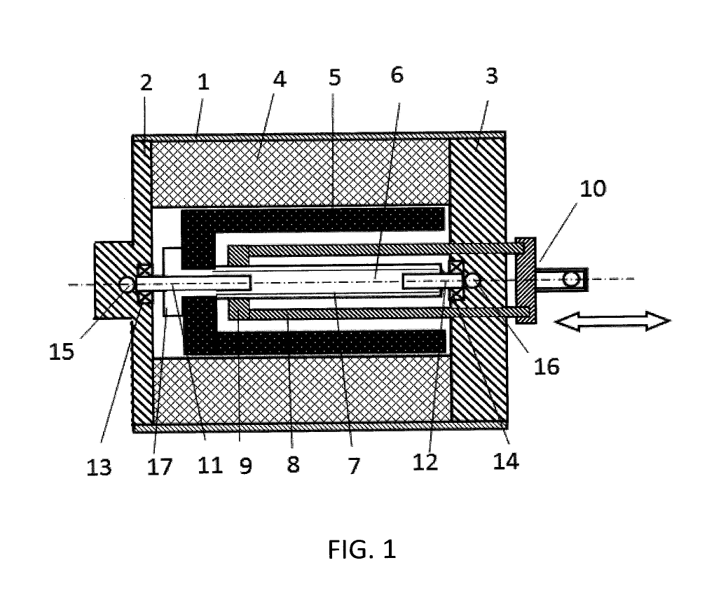

In one embodiment, the greatly schematized representation according to FIG. 1 depicts a linear stepper motor in cross section. Substantially, it includes a motor housing 1 with two bearing shields 2, 3 which close the housing 1 at its opposite ends, a stator 4, a rotor including a rotor magnet 5 and a plastic rotor shaft 6 having a motive thread 7 formed on it, and an actuating rod 8 of a fork-shaped design which is linearly operable by the rotor shaft 6 and which has a spindle nut 9 at its fork base to engage with the motive thread 7 of the rotor shaft 6. The spindle nut 9 can be formed directly at the actuating rod 8 or it is embedded in the fork base in a rotation-locked manner. The actuating rod 8 itself is guided by the drive bearing shield 3 in a rotation-locked manner. Outside the drive bearing shield 3, a customer-specific function head 10, which is, e.g., plugged on the two legs of the fork-shaped actuating rod 8, closes the actuating rod 8 axially. The rotor shaft 6 is supported by the two bearing shields 2, 3. The actuating rod 8 is guided on the rotor shaft 6, on the one hand, and by the drive bearing shield 3, on the other hand. Specifically, according to FIG. 1, the plastic rotor shaft 6 has coaxial metallic journals as plain bearing journals 11, 12 which are of high surface quality and are guided with wear resistance, low maintenance and minimum play in the bearing shields 2, 3 both radially by roller bearings 13, 14 and axially by means of a ball bearing 15, 16. On the non-drive side, the rotor shaft 6 is provided with a neck flange 17 which connects the rotor shaft 6 to the rotor magnet 5 in an especially rotation-locked manner. According to the disclosure, a rotation-locked connection between the plain bearing journals 11, 12 and the rotor shaft 6 is not a prerequisite because the rotor 6 can rotate relative to the plain bearing journals 11, 12 in another embodiment.

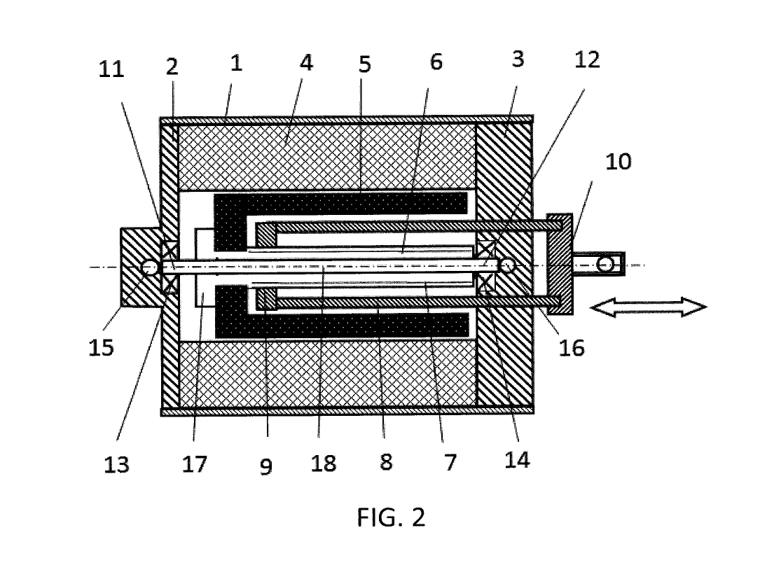

In an alternative embodiment, the linear stepper motor according to FIG. 2 has a design similar to the design of FIG. 1. However, the rotor shaft 6 differs from FIG. 1 by the fact that the two plain bearing journals 11, 12 are linked in form of a one-piece continuous journal axle 18 either of metal or consisting partly of separate plastic materials, running coaxially through the rotor shaft 6.

The disclosure is particularly suited for valve actuators.

1. A linear stepper motor comprising a rotor, two plain bearings, two motor bearing shields, a spindle nut, and a fork-shaped actuating rod;
wherein the rotor comprises a rotor shaft that comprises a motive thread and is configured to drive a linearly guided actuator, the rotor shaft comprises plain bearing journals at ends thereof, which each comprise an end radially and axially enclosed in the plain bearings seated in the motor bearing shields, and, by the motive thread, axially drives the spindle nut connected with the fork-shaped actuating rod in a rotation-proof manner;
wherein the rotor shaft comprises a flexurally and torsionally rigid plastic threaded spindle with coaxially arranged metallic shaft ends so as to act as metallic journals on opposite ends for concurrent plain bearing support and axial support.

2. The linear stepper motor according to claim 1, wherein two metallic journals arranged coaxially at opposite ends of the rotor shaft form the two plain bearing journals and are fastened to the flexurally and torsionally rigid plastic threaded spindle with a plastic core.

3. The linear stepper motor according to claim 1, wherein a continuous metallic journal axle is guided through the plastic threaded spindle, and opposite end portions of the journal axle form the two plain bearing journals.

4. The linear stepper motor according to claim 3, wherein the plain bearing journals or the journal axle is connected to the rotor shaft in a rotation-locked manner.

5. The linear stepper motor according to claim 3, wherein the plain bearing journals or the journal axle is rotatable with respect to the rotor shaft.

6. The linear stepper motor according to claim 1, wherein a neck flange is molded on a non-drive side of the rotor shaft for a rotation-locked connection with a rotor magnet of the rotor.

7. The linear stepper motor according to claim 6, wherein by injection molding of the rotor shaft, the rotor magnet is insert-molded.

8. The linear stepper motor according to claim 1, wherein the motive thread is a trapezoidal thread.
